(19) United States
(12) Patent Application Publication
(10) Pub. No.: US 2002/0140284 A1
(43) Pub. Date: Oct. 3, 2002

(54) ABS actuator with drain port conduit

(76) Inventors: Fumitoshi Koyama, Kariya-city (JP); Kouji Aoba, Kariya-city (JP); Takayuki Shibata, Nagoya-city (JP); Taizo Abe, Takahama-city (JP)

Correspondence Address: LAW OFFICE OF DAVID G. POSZ, 2000 L STREET, N.W., SUITE 200, WASHINGTON, DC, 20036, US

(21) Appl. No.: 10/105,328

(22) Filed: Mar. 26, 2002

(30) Foreign Application Priority Data
Mar. 27, 2001 (JP) 2001 - 90982

(51) Int. Cl. B60T 8/40

(52) U.S. Cl. 303/116.4

(57) ABSTRACT

A drain port conduit of an ABS actuator, which extends in a housing straight and perpendicularly to ground for making a backpressure chamber communicate with an outside of the housing, is provided on a side of the backpressure chamber with a small diameter portion and on a side of the ground with a large diameter portion. A ring plate is press fitted to the large diameter portion at an axial end thereof on a side of the ground. A diameter of a hole of the ring plate is smaller than an inner diameter of the small diameter portion so that water is restrained from entering into the drain port conduit and, even if entered, from reaching the backpressure chamber.

### CROSS REFERENCE TO RELATED APPLICATION

This application is based upon and claims the benefit of priority of Japanese Patent Applications No. 2001-90982 filed on Mar. 27, 2001, the content of which is incorporated herein by reference.

### BACKGROUND OF THE INVENTION

1. Field of the Invention

The present invention relates to an ABC actuator with a drain port conduit for controlling brake pressure of wheel cylinders of a vehicle.

2. Description of Related Art

An ABS actuator is a hydraulic device for controlling pressure increase and decrease in wheel cylinders so that symptom of wheel lock may be avoided. As shown in FIGS. 6 and 7, A conventional ABS actuator J1 has a housing J2, a motor J3 assembled to the housing J2, a cam J4 to be driven by the motor J3 through a motor shaft 9, a pump chamber J5 accommodating the cam J4, a piston pump having pistons J6 protruding in the pump chamber J5 and reservoirs J8. The pistons J6 are driven by the cam J4 so that brake fluid reserved in the reservoirs J8 is sucked and discharged at a time of ABS control.

The housing J2 further has a drain port conduit J9 through which the pump chamber J5 communicates with outside. The drain port conduit J9 extends from the pump chamber J5 toward the ground (earth). The drain port conduit J9 is provided at a portion opened to the ground with a cap J10 that is axially movable and prevents water from entering into the pump chamber J5 therethrough, when water is poured over the ABS actuator J1. The cap J10, which is made of material that floats on water, has one axial end closed cylindrical portion whose outer circumference is provided with a groove or grooves extending axially and a flange J 11 radially protruding out of the outer circumference of the cylindrical portion at the axial end thereof. When water is not poured over the ABS actuator J1, that is, at a normal time, the flange J11 of the cap J10 is positioned away from the housing J2 so that the pump chamber J5 communicates with outside through the groove opened radially. On the other hand, when water is poured over the ABS actuator J1, the flange J11 comes in contact with the housing J2, since the cap J10 floats on water, so that the groove is not opened to outside, which results in preventing water from entering into the pump chamber J5.

However, the conventional ABS has a drawback that, when the vehicle wheel splashes water over the cap J10 in a direction oblique to the drain port conduit J9, that is, over the circumference of the cylindrical portion of the cap J10 having the groove opened radially, water is prone to enter into the drain port conduit J9 through the groove of the cap J10, since the cap J10 is positioned away from the housing J2 at this time. If an amount of water entered into the drain port conduit J9 is relatively large and exceeds a given volume of the drain port conduit J9, water reaches the pump chamber J5.

### SUMMARY OF THE INVENTION

An object of the invention is to provide an ABS actuator with a drain port conduit into which water struck obliquely thereon is unlikely to enter.

Another object of the invention is to provide an ABS actuator with a drain port conduit through which water is prevented from entering into a backpressure chamber.

To achieve any of the above objects, the ABS actuator has a housing, a backpressure chamber provided in the housing, a drain port conduit extending from the backpressure chamber toward outside substantially straight and perpendicularly to ground and a water invasion restriction member fixed to the housing at an axial end of the drain port conduit on a side of the ground. The water invasion restriction member, preferably, a ring plate, has a hole whose one end communicates with the drain port conduit and whose the other end is opened to the outside only perpendicularly to the ground. A diameter of the hole of the water invasion restriction member is smaller than an inner diameter of the drain port conduit.

With the ABS actuator mentioned above, the water invasion restriction member serves to refrain water struck obliquely on a bottom of the housing from entering into the drain port conduit.

It is preferable that the drain port conduit comprises a small diameter portion located on a side of the backpressure chamber and a large diameter portion located on a side of the ground. An inner diameter of the large diameter portion is larger than that of the small diameter portion. With this construction, even if the water is entered into the drain port conduit through the hole of the water invasion restriction member, the water is prevented from entering into the backpressure chamber, since the large diameter portion has a space volume for adequately reserving the water.

### BRIEF DESCRIPTION OF THE DRAWING

Other features and advantages of the present invention will be appreciated, as well as methods of operation and the function of the related parts, from a study of the following detailed description, the appended claims, and the drawings, all of which form a part of this application. In the drawings:

FIG. 1 is a partly exploded schematic view of an ABS actuator according to a first embodiment of the present invention;

FIG. 2 is a cross sectional view taken along a line II-II of FIG. 1;

FIG. 3A is a partly enlarged cross sectional view of a drain port conduit of FIG. 1;

FIG. 3B is a plane view of the drain port conduit of FIG. 3A;

FIG. 4A is a partly enlarged cross sectional view of a drain port conduit according to a second embodiment of the present invention;

FIG. 4B is a plane view of the drain port conduit of FIG. 4A;

FIG. 5A is a partly enlarged cross sectional view of a drain port conduit according to a third embodiment of the present invention;

FIG. 5B is a plane view of the drain port conduit of FIG. 5A;

FIG. 6 is a partly exploded schematic view of a conventional ABS actuator as a prior art; and

FIG. 7 is a cross sectional view taken along a line VII-VII of FIG. 6.

### DETAILED DESCRIPTION OF THE PREFERRED EMBODIMENTS

(First Embodiment)

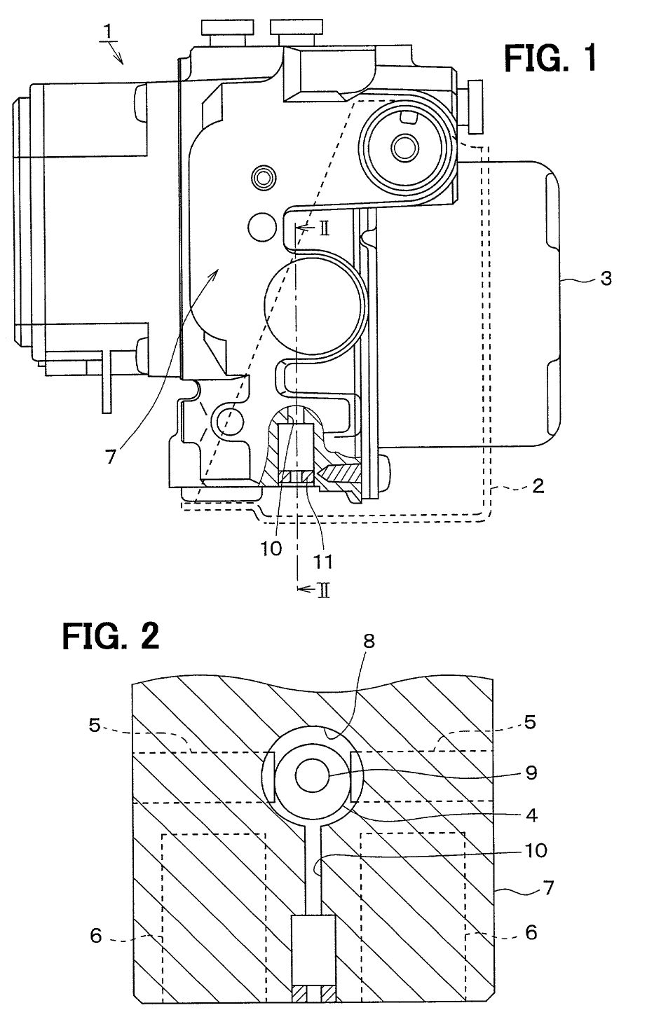

A first embodiment of the present invention is described with reference to FIGS. 1 and 2.

An ABS actuator 1 is provided to bridge hydraulically between a master cylinder and wheel cylinders and controls to avoid a symptom of vehicle wheel lock on braking a vehicle. The ABS actuator 1 is mounted via a bracket 2 on the vehicle in such a manner that the upper and lower sides of drawings in FIGS. 1 and 2 correspond to heaven and earth (ground) sides, respectively.

As shown in FIGS. 1 and 2, the ABS actuator 1 has a housing 7 with which a motor 3, a cam 4, a pump 5 and a reservoir 6 are integrated into one body.

The housing 7 is formed substantially in a hexahedral shape and, as shown in FIG. 1, provided with a top surface on the upper side of the drawing, a bottom surface on the lower side of the drawing and a side surface connecting the top and bottom surfaces. The motor 3 is mounted on a part of the side surface of the housing 7. A dive shaft 9 of the motor 3 is inserted into a pump chamber 8 that is formed in the housing 7 as a backpressure chamber. An eccentric cam 4 is assembled to the drive shaft 9 in the pump chamber 8 so that, when the motor 3 is energized, the cam 4 rotates eccentrically.

The pump 5 is composed of, for example, a pair of pistons that are disposed in the housing 7 on opposite sides of the drive shaft 9 in an axial direction thereof. The pump 5 performs a pump operation in such a manner that each of the pistons makes a reciprocal movement according to the rotation of the cam 4. The reservoir 6 is provided at the bottom surface of the housing 7. The reservoir 6 reserves brake fluid released from the wheel cylinders, typically, at a time of ABS control. The brake fluid reserved in the reservoir 6 is sucked and delivered by the pump 5, for example, to be returned to the master cylinder.

A drain port conduit 10, whose one end is connected to the pump chamber 9 and whose the other end is opened to the bottom surface of the housing 7, is provided in the housing 7 to make the pump chamber 8 communicate with outside.

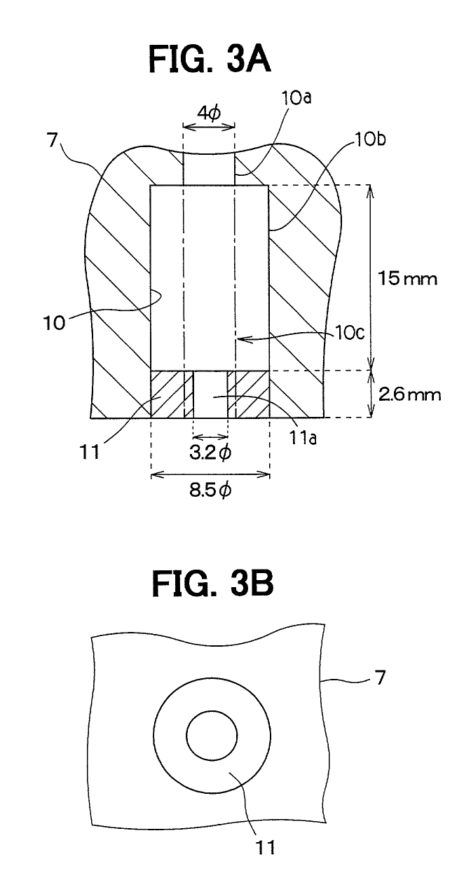

As shown in FIGS. 3A and 3B, the drain port conduit 10, which is formed in a step shape, has a small diameter portion 10a on a side of the pump chamber 8 and a large diameter portion 10b on a side of the bottom surface of the housing 7. A ring plate 11 is press fitted to an inner wall of the large diameter portion 10b at an axial end thereof on a side of the ground. A diameter of an opening or hole 11a of the ring plate 11 is smaller than each inner diameter of the small and large diameter portions 10a and lob. For example, the inner diameter of the small diameter portion 10a is 4 mm, the inner diameter of the large diameter portion 10b is 8.5 mm and the diameter of the opening 11a of the ring plate 11 is 3.2 mm. An axial length of the large diameter portion 10b between the small diameter portion 10a and the ring plate 11 is 15 mm. An axial length of the ring plate 11 is 2.6 mm. As noticed from theses dimensions, an volume of an inner space formed by the large diameter portion 10b is about 851 mm³ (about 800 mm³), which is larger by more than four times than a volume 189 mm³ (about 200 mm³) of an inner space of a hypothetical portion 10c which would have be formed, if the small diameter portion 10a is continuously extended, since the inner diameter of the large diameter 10b is larger by more than twice than that of the small diameter portion 10a.

According to the first embodiment mentioned above, an area of the opening 11a of the ring plate 11 opened to outside is smaller than an opening area of the small diameter portion 10a, so that water is less entered into the drain port conduit 10, compared with a case that the small diameter portion 10a is more axially extended hypothetically so as to be opened directly to outside.

Further, the opening 11a of the ring plate 11 is opened axially to the ground, that is, in a direction perpendicular to the ground, but never opened radially so that, when water is struck over the drain port conduit 10 obliquely to an axial direction thereof, the water may be refrained from entering into the drain port conduit 10.

Furthermore, even if the water is entered into the drain port conduit through the opening 11a of the ring plate 11, the water is prevented from reaching the backpressure chamber 8, since the large diameter portion 10b has a space volume enough to reserve the water, preferably, more than 200 mm³, more preferably, more than 800 mm³.

Moreover, a part of the bracket 2 is interposed between the opening of the ring plate and the ground. Accordingly, if the water is splashed toward the drain port conduit in an axial direction thereof, that is, perpendicularly to the ground, the bracket 2 prevents the water from entering into the drain port conduit 10 through the opening of the ring plate 11.

(Second Embodiment)

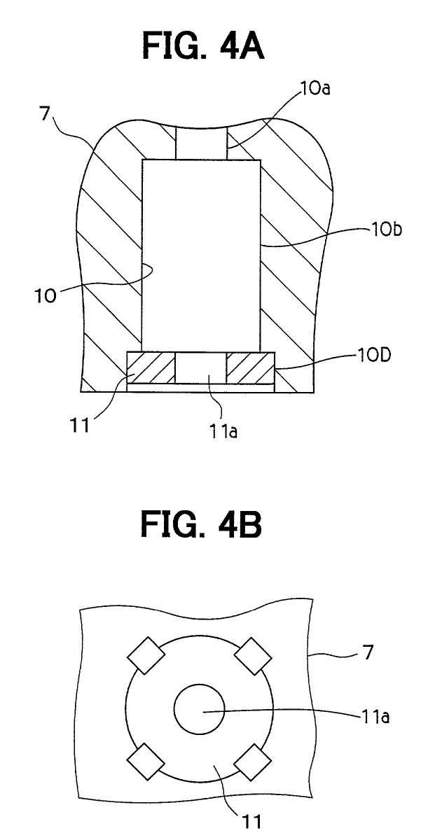

An ABS actuator according to a second embodiment is described with reference to FIGS. 4A and 4B. The second embodiment differs from the first embodiment in a manner through which the ring plate 11 is fixed to the housing 7.

According to the second embodiment, the housing 7 is provided at an axial end of the large diameter portion on a side of the bottom surface thereof with a step portion 10d whose inner diameter is larger than that of the large diameter portion 10b and corresponds to an outer diameter of the ring plate 11 and whose axial length is equal or slightly larger than that of the ring plate 11. After the ring plate 11 is fitted in the step portion 10d, a part of circumferential periphery of the step portion 10d around the ring plate 11 is staked or crimped so that the ring plate is rigidly fixed to the housing 7.

(Third Embodiment)

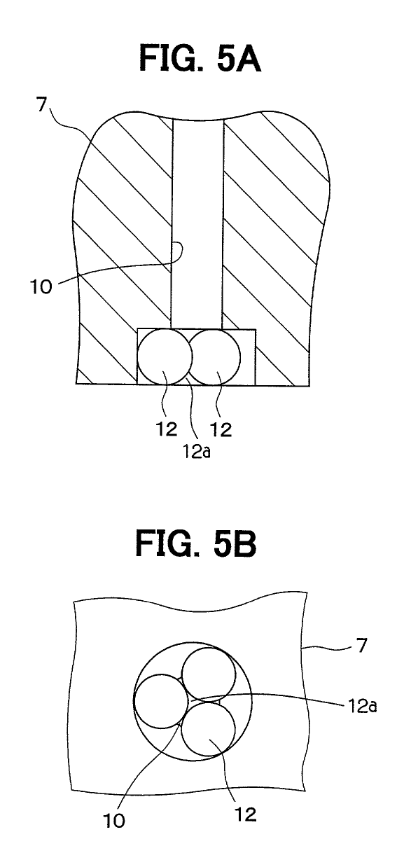

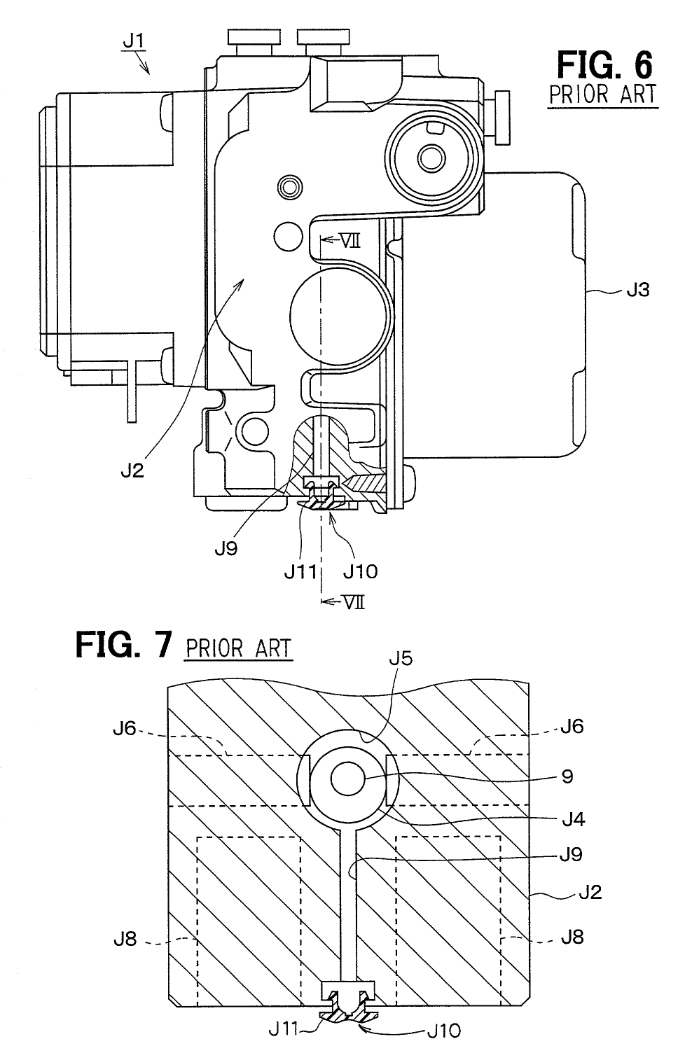

An ABS actuator according to a third embodiment is described with reference to FIGS. 5A and 5B.

The third embodiment has three balls 12 in place of the ring plate 11 according to the second embodiment. The three balls 12 in contact with one another and arranged to constitute a regular triangle shape are press fitted in the step portion 10d in a state that each of the balls 12 is in contact with a bottom surface of the step portion 10d parallel to the bottom surface of the housing 7.

As all openings or gaps 12a among the three balls 12 are opened to outside in an axial direction of the drain port conduit 10 and there are no openings among the three balls 12 opened radially to outside so that water splashed obliquely to the drain port conduit 10 is refrained from entering into the drain port conduit 10 through the openings among the balls 12.

A total area of the openings 12a among the balls 12 is smaller than the opening area of the small diameter portion 10a. Accordingly, the water splashed is less entered into the drainport conduit 10, compared with a case that the small diameter portion 10a is more axially extended hypothetically so as to be opened directly to outside, similarly to the first or second embodiment.

Instead of three balls 12, a plurality of balls whose piece number is larger than three may be press fitted to the step portion 10d in such a manner that the plural balls are in contact with one another to constitute a polygonal shape and also in contact with the bottom surface of the step portion 10d.

As mentioned above, each of the ring plate 11 and the balls 12 according to the first to third embodiment constitutes a water invasion restriction member whose opening or hole 11a or 12a is opened to the outside perpendicularly to the ground so that water struck obliquely on the bottom surface of the housing 7 is refrained from entering into the drain port conduit 10.

Instead of the drain port conduit having the small and large diameter portions 10a and 10b as described in the first to third embodiments, the drain port conduit 10 may have an entirely uniform diameter conduit and the water invasion restriction member mentioned above may be attached on the entirely uniform diameter conduit, as far as the opening area of the water invasion restriction member opened to the outside perpendicularly to the ground is smaller than an area of the uniform diameter hole.

Further, in the first to third embodiments mentioned above, instead of the piston pump 5, a gear pump such as a trochoid pump may be applied. In this case, a room where the gear pump is accommodated constitutes the backpressure chamber 8.

What is claimed is:

1. An ABS actuator comprising:
a housing;
a backpressure chamber provided in the housing;
a drain port conduit extending from the backpressure chamber toward outside substantially straight and perpendicularly to ground for making the backpressure chamber communicate with the outside; and
a water invasion restriction member fixed to the housing at an axial end of the drain port conduit on a side of the ground, the water invasion restriction member having a hole whose one end communicates with the drain port conduit and whose the other end is opened to the outside only perpendicularly to the ground,
wherein a diameter of the hole of the water invasion restriction member is smaller than an inner diameter of the drain port conduit.

2. An ABS actuator according to claim 1, wherein the drain port conduit comprises a small diameter portion located on a side of the backpressure chamber and a large diameter portion located on a side of the ground, an inner diameter of the large diameter portion being larger than that of the small diameter portion and, further, the water invasion restriction member being arranged at an axial end of the large diameter portion on a side of the ground.

3. An ABS actuator according to claim 2, wherein the water invasion restriction member is a ring plate whose inner hole diameter is smaller than the inner diameter of the small diameter portion.

4. An ABS actuator according to claim 3, wherein the ring plate is press fitted to an inner wall of the large diameter portion.

5. An ABS actuator according to claim 3, wherein the drain port conduit further comprises a step portion which is located at an axial end of the large diameter portion on a side of the ground and whose inner diameter is larger than that of the large diameter portion, the ring plate is fixed to the step portion by staking a part of circumferential periphery of the step portion around the ring plate.

6. An ABS actuator according to claim 2, wherein a space volume of the large diameter portion is more than 200 mm³.

7. An ABS actuator according to claim 2, wherein a space volume of the large diameter portion is more than 800 mm³.

8. An ABS actuator according to claim 2, wherein the drain port conduit further comprises a step portion which is located at an axial end of the large diameter portion on a side of the ground and whose inner diameter is larger than that of the large diameter portion and, further, wherein the water invasion restriction member is a plurality of balls accommodated in the step portion and contacted with one another in a polygonal shape, whereby gaps among the balls constitute the hole of the water invasion restriction member.

9. An ABS actuator according to claim 8, wherein the balls are press fitted to an inner sidewall of the step portion.
